(19) United States
(12) Patent Application Publication
(10) Pub. No.: US 2010/0132567 A1
(43) Pub. Date: Jun. 3, 2010

(54) COOKING TRAY

(76) Inventor: Karl O. Lee, Downers Grove, IL (US)

Correspondence Address: MCANDREWS HELD & MALLOY, LTD, 500 WEST MADISON STREET, SUITE 3400, CHICAGO, IL, 60661, US

(21) Appl. No.: 12/702,533

(22) Filed: Feb. 9, 2010

Related U.S. Application Data
(63) Continuation-in-part of application No. 11/075,248, filed on Mar. 8, 2005.

(51) Int. Cl. A23P 1/00; B65D 25/04; B65D 45/16; F24B 1/182

(52) U.S. Cl. 99/426; 220/553; 220/324; 126/506

(57) ABSTRACT

A self-contained cooking system includes a foldable case including a tray compartment and at least one heating element compartment. The heating element compartment is configured to securely retain a portable heating device, such as a propane or butane stove and respective gas canisters. The system also includes a cooking tray removably secured within the tray compartment.

### RELATED APPLICATIONS

This application is a continuation-in-part of U.S. patent application Ser. No. 11/075,248 entitled “Cooking Tray,” filed Mar. 8, 2005, which is hereby incorporated by reference in its entirety.

### BACKGROUND OF THE INVENTION

Embodiments of the present invention generally relate to a cooking tray that may be used for outdoor camping, and more particularly to a cooking tray configured to reduce the amount of cookware needed to prepare camp meals.

Use of gas-fired grills and other cooking assemblies for camping are well known in the prior art. Gas fired grills and portable propane cooking burners along with pots and pans have been the mainstay for outdoor food preparation for generations. Cooking equipment for camping typically includes multiple pots and pans that are separately packed and carried by a camper. However, multiple pots and pans add weight and bulk to a camper's load and generally are not well-suited for wilderness camping, backpacking or other back-country travel.

Thus, a need exists for an efficient, inexpensive, lightweight system for cooking outdoors. Further, a need exists for a cooking system that is easily packed and carried by a camper.

### SUMMARY OF THE INVENTION

Embodiments of the present invention provide an improved cooking apparatus for camping that minimizes cost, packing space and cleanup required for meal preparation while camping by providing an integrated cooking tray with two distinct cooking areas. The novel integrated cooking tray comprises a recessed portion that provides a distinct cooking area for simultaneous preparation of multiple food types, such as pancakes and bacon, hot dogs and beans, as well as a place to simmer marinades for grilled fish, meat and poultry. The improved cooking apparatus also has several other advantages, such as ease of clean-up, reduced cost for equipment and minimizing packing space needed for cooking gear.

The integrated cooking tray of the present invention has two distinct cooking areas. One cooking area is recessed so that it has a bottom and perpendicular sidewall extending around the outer circumference thereof. The second cooking area is a flat plate. The perimeter of the flat plate portion of the tray has a molded channel that is intended to collect oil and other liquids during cooking. The two areas are of sufficient size to permit simultaneous preparation of typical camp foods and the recessed portion is of sufficient volume to retain the second food type or marinade away from the first food type.

The integrated cooking tray is configured to be positioned on top of two portable propane or butane cooking burners and is made out of heat conductive material having a non-stick surface. The heat conductive material may be a metal such as aluminum having a Teflon coating. The cooking tray may be an integrally molded piece of unitary metal.

Certain embodiments of the present invention may also include a drip well for collecting grease or other such run-off away from the non-recessed cooking surface.

Certain embodiments of the present invention may also include molded slots formed on the bottom of the cooking tray to accommodate the burner grate of a standard disposable propane tank used for camping. As such, one may prepare a meal using only inexpensive cooking burners such as conventional disposable propane tanks and the present integrated cooking tray, thereby eliminating the need for a more cumbersome stove or grill.

Certain embodiments of the present invention provide a cooking system configured to be used with at least one separate heating element. The system includes a main body comprising an integrally formed first cooking area and an integrally formed second cooking area. The first cooking area is separate and distinct from the second cooking area. The main body may be a unitary piece of metal.

The first cooking area is integrally connected to the second cooking area through an intermediate portion. The first cooking area may include a flat cooking surface surrounded by a drainage channel, while the second cooking area may include a recessed cooking pocket.

Both the first and second cooking areas include a burner grate mount configured to securely mount to a burner grate of a heating element. The burner grate mount may include downwardly-extending pie-shaped portions separated by arcuate gaps. The system may also include a ridge downwardly extending from the main body, wherein the ridge is configured to limit movement of the main body when positioned on the at least one heating element.

The system may also include retractable legs operatively connected to the main body. The legs may be moved to an extended position, in which the legs support the main body, and a retracted position, in which the legs are folded under the main body.

Certain embodiments of the present invention provide a cooking system that includes a foldable case including a cooking tray compartment and at least one heating device compartment. The heating device compartment(s) is configured to securely retain a portable heating device, such as a propane or butane stove. The system also includes a cooking tray removably secured within the tray compartment.

The foldable case may be pivotable between open and closed positions. The cooking tray and the heating device are securely contained within the foldable case in the closed position.

The cooking tray may include a main body including an integrally formed first cooking area and an integrally formed second cooking area. The first cooking area is separate and distinct from the second cooking area. Optionally, the cooking tray may include a single cooking area such as a circular cooking disc having a cooking surface and an annular support extending downward from a side opposite the cooking surface.

In general, the cooking tray may include at least one annular support configured to support the cooking tray above the heating device(s).

The case may include a cover latchably secured to a base. The cover may include the cooking tray compartment and the base may include the heating device compartment(s).

The case is operable to be opened and closed. The cooking tray and heating device are removed from their compartments and the cooking tray positioned over the heating device.

The case may also include at least one semi-cylindrical compartment configured to removably retain a canister of fuel such as portable propane or butane fuel canisters

### BRIEF DESCRIPTION OF SEVERAL VIEWS OF THE DRAWINGS

FIG. 1 illustrates a top view of a cooking tray according to an embodiment of the present invention.

FIG. 2 illustrates a bottom view of a cooking tray according to an embodiment of the present invention.

FIG. 3 illustrates an isometric bottom view of a cooking tray according to an embodiment of the present invention.

FIG. 4 illustrates a transverse cross-sectional view of a cooking tray through line 4-4 of FIG. 1.

FIG. 5 illustrates a side view of a cooking tray according to another embodiment of the present invention.

FIG. 6 illustrates a bottom view of a cooking tray according to an embodiment of the present invention.

FIG. 7 illustrates an isometric bottom view of a cooking tray according to an embodiment of the present invention.

FIG. 8 illustrates a top isometric view of a case according to an embodiment of the present invention.

FIG. 9 illustrates a top isometric view of a self-contained cooking system according to an embodiment of the present invention.

FIG. 10 illustrates a top isometric view of a case in an open position according to an embodiment of the present invention.

FIG. 11 illustrates an isometric top view of a cooking plate according to an embodiment of the present invention.

FIG. 12 illustrates an isometric bottom view of a cooking plate according to an embodiment of the present invention.

FIG. 13 illustrates an isometric top view of a case in an open position according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

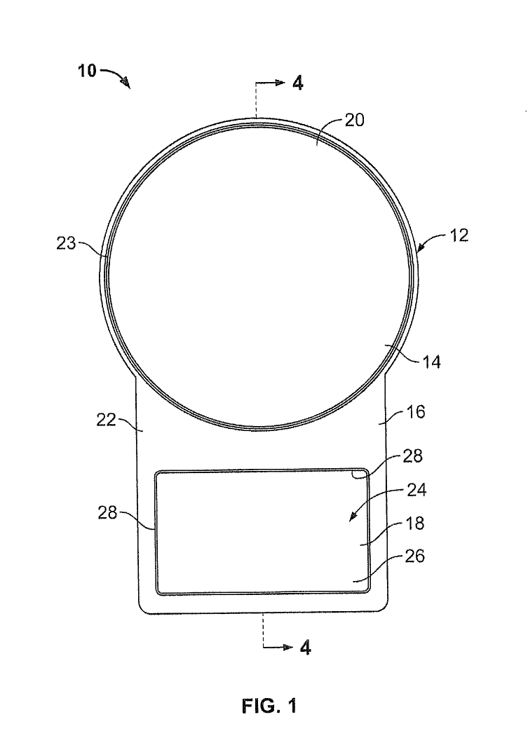

FIG. 1 illustrates a top view of a cooking tray 10 according to an embodiment of the present invention. The cooking tray 10 may be formed of a metal, such as aluminum having a Teflon coating. The cooking tray 10 includes a main body 12 having a first cooking area 14 integrally formed with an intermediate portion 16, which is, in turn, integrally formed with a second cooking area 18.

The first cooking area 14 includes a flat cooking surface 20 that is coplanar with a top surface 22 of the intermediate portion 16. A drainage channel 23 is formed about the outer circumference of the cooking surface 20, and is configured to receive grease or other runoff from food material that is cooked on the cooking surface 20. While the first cooking area 14 is shown as a circular cooking area, the first cooking area 14 may be various shapes and sizes, including rectangular, square, triangular, or the like. Further, instead of being a flat cooking surface that is coplanar with the top surface 22, the cooking surface may be recessed below the top surface 22 of the intermediate portion 16.

The second cooking area 18 includes a sunken cooking pocket 24 defined by a base 26 integrally formed with side walls 28, which may be perpendicular to the base 26. The second cooking area 18 is recessed below the plane of the top surface 22 of the intermediate portion 16. While the second cooking area 18 is shown as a rectangular cooking area, the second cooking area 18 may be various shapes and sizes, including circular, square, triangular, or the like. Further, instead of including a recessed cooking pocket, the second cooking area 18 may include a flat cooking surface that is coplanar with the top surface 22 of the intermediate portion 16.

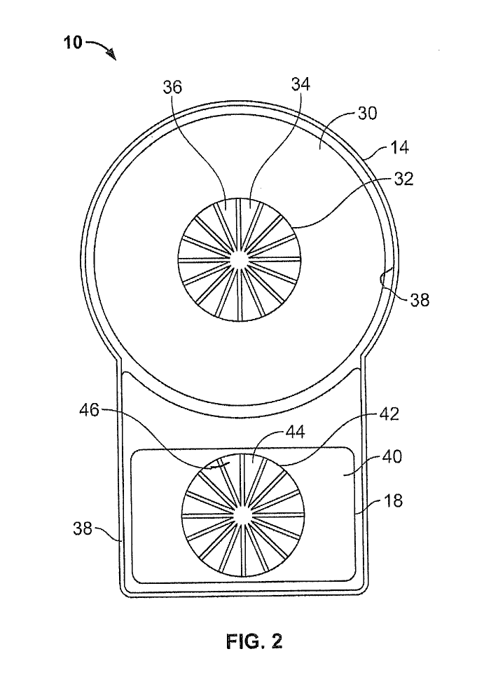

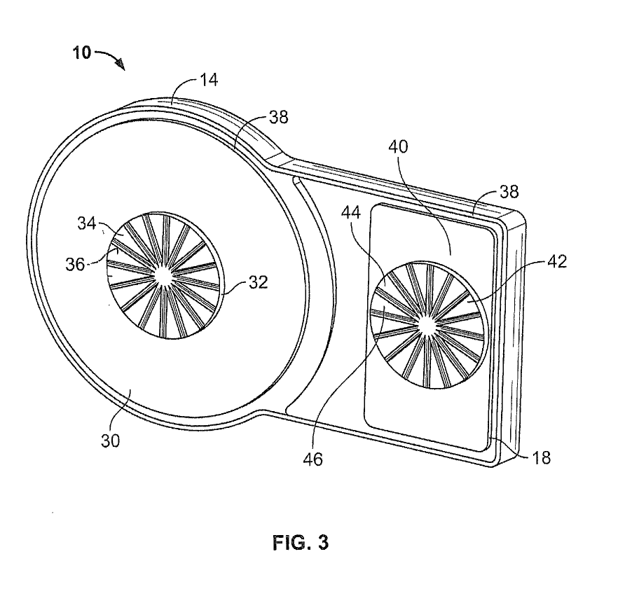

FIG. 2 illustrates a bottom view of the cooking tray 10. FIG. 3 illustrates an isometric bottom view of the cooking tray 10. Referring to FIGS. 2 and 3, the first cooking area 14 includes a bottom surface 30 configured to be positioned over a heating element, such as a standard disposable propane tank. A burner grate mount 32 is formed about a center of the bottom surface 30. The burner grate mount 32 is configured to securely mount to a burner grate of a heating element.

The burner grate mount 32 has downwardly-extending pie-shaped portions 34, and arcuate gaps 36. Each downwardly extending portion 34 is positioned between two gaps 36. The pattern of downwardly-extending portions 34 and gaps 36 is configured to cooperate with corresponding features on the burner grate to securely mount the burner grate mount 32 on top of the burner grate. Optionally, the burner grate mount 32 may include a plurality of panels or fins, each having a slot formed therethrough. The slots may be configured to receive and retain fins of a burner grate. In general, the burner grate mount 32 may be shaped and configured to accommodate various types of burner grates.

Additionally, a downwardly extending ridge 38 surrounds the bottom surface 30. The downwardly extending ridge 38 is configured to engage the neck of a heating element, if the cooking tray 10 is shifted during cooking. As such, the ridge 38 acts to halt horizontal movement of the first cooking area 14 with respect to the heating element so that the cooking tray 10 does not slide off the heating element.

The second cooking area 18 includes a bottom surface 40 configured to be positioned over a heating element, such as a standard disposable propane tank. Similar to the first cooking area 14, a burner grate mount 42 is formed about a center of the bottom surface 40 and is configured to securely mount to a burner grate of a heating element.

The burner grate mount 42 has downwardly-extending portions 44 and gaps 46, that are configured to cooperate with corresponding structures of the burner grate (similar to that described above with respect to the burner grate mount 32). Optionally, the burner grate mount 42 may include a plurality of downwardly-extending panels or fins, each having a slot formed therethrough, that are configured to receive and retain fins of a burner grate.

The downwardly-extending ridge 38 surrounds the bottom surface 40, as well as the bottom surface 30. Thus, the ridge 38 acts to halt horizontal movement of the second cooking area 18 with respect to the heating element so that the cooking tray 10 does not slide off the heating element.

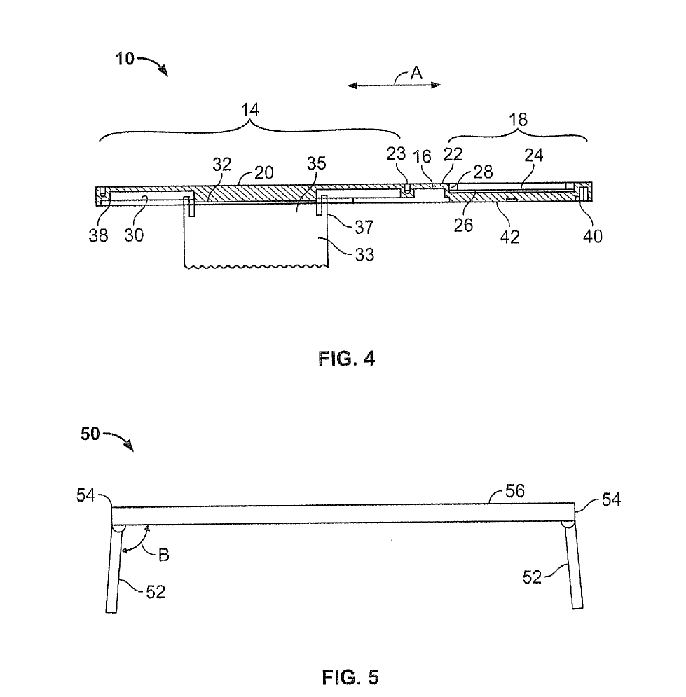

FIG. 4 illustrates a transverse cross-sectional view of the cooking tray 10 through line 4-4 of FIG. 1. As shown in FIG. 4, the first cooking surface 20 is coplanar with the top surface 22 of the intermediate portion 16. The sunken cooking pocket 24 is recessed below the top surface 22 of the intermediate portion 16. A first food item may be cooked on the first cooking surface 20. Grease or run-off from the first food item may drain and collect into the drainage channel 23.

A second food item may be cooked within the sunken cooking pocket 24. Food items on the first and second cooking areas 14 and 18 are separated from one another. The drainage channel 23 ensures that grease and runoff from a food item on the first cooking surface 20 does not contact the food item in the sunken cooking pocket 24. Further, a food item in the sunken cooking pocket 24 remains within the sunken cooking pocket 24 by virtue of the side walls 28. The sunken cooking pocket 24 may also include a drip well formed through the base 26 or 28 that allows grease and runoff to pass through the sunken cooking pocket 24.

A simplified heating element 33 having a burner grate 35 and a neck 37 is shown positioned underneath the first cooking area 14. While only one heating element 33 is shown, it is to be understood that another heating element 33 may be positioned underneath the second cooking area 18.

As discussed above with respect to FIG. 2, the burner grate mounts 32 and 42 securely mount to the tops of burner grates of separate heating elements. The outer ridge 38 downwardly-extending around the cooking tray 10 ensures that the cooking tray 10 does not slide off the heating elements in the directions denoted by arrow A. For example, while the cooking tray 10 may slide over a short distance in the directions denoted by arrow A, the ridge 38 will engage a neck of the heating element when the cooking tray 10 slides too far, thereby limiting the range of motion of the cooking tray 10 over the heating element(s).

Alternatively, the underside of the cooking tray 10 may be configured to provide an interference fit with a top of a heating element, such as a propane heater. That is, the underside of the cooking tray 10 may include slots, channels, and tabs that are configured to correspond to the features of the top of the heater. Further, the cooking tray may be configured to snapably, threadably, or otherwise removably engage the burner grates, and/or the entire top of a heating element.

The cooking tray 10 may also include handles extending from the main body 12. For example, handles may laterally extend from the intermediate portion 16, or a handle may upwardly extend from the top surface 22 of the intermediate portion 16. Optionally, a handle(s) may extend from outer edges of the first and/or second cooking areas 14 and 18.

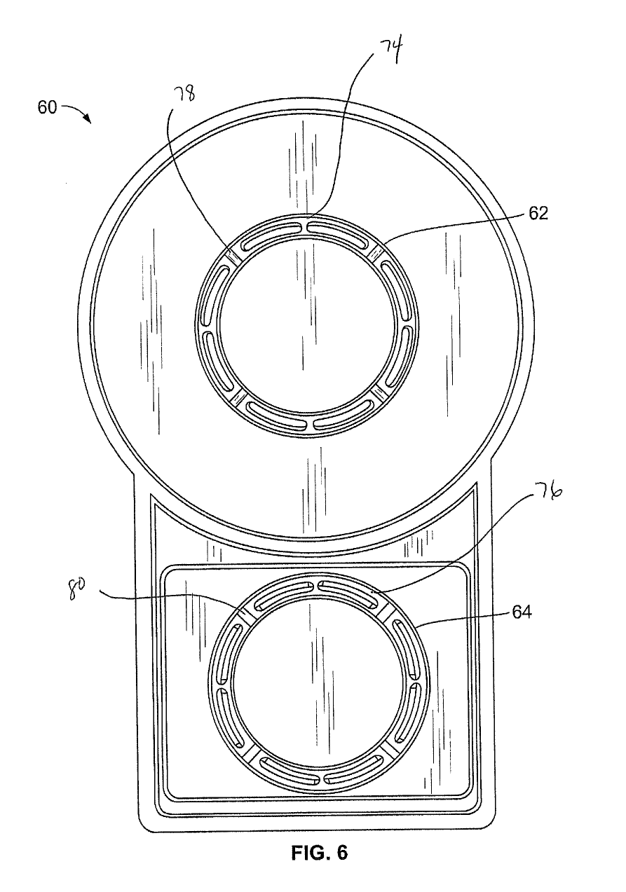

FIG. 5 illustrates a side view of a cooking tray 50 according to another embodiment of the present invention. The cooking tray 50 may include hinged legs 52 operatively connected to respective ends 54 a main body 56. The hinged legs 52 may be moved between extended and retracted positions in directions denoted by arrow B. The hinged legs 52 may be extended so that the cooking tray 10 may stand up. In this way, the cooking tray 50 may be used to cook over an open fire. The legs 52 may then be folded underneath the main body 56 when the cooking tray 50 is not in use. The legs 52 may move through extended and retracted positions through various systems. For example, the legs may be hinged, telescoping, foldable, or the like.

Embodiments of the present invention provide an efficient, lightweight system for cooking outdoors that is easily packed and carried by a camper. Embodiments of the cooking tray minimize cost, packing space and cleanup due to the fact that they eliminate the need for multiple pots and pans, a separate stove surface, and bulky heating devices. The cooking tray 10 may be used with small conventional heating elements, such as 16.4 oz disposable propane tanks with detachable burner grates and butane stoves with 8 oz disposable cartridges.

The separate and distinct cooking areas of the cooking tray enable simultaneous preparation of multiple food types, such as pancakes and bacon, hot dogs and beans, as well as a place to simmer marinades for grilled fish, meat and poultry.

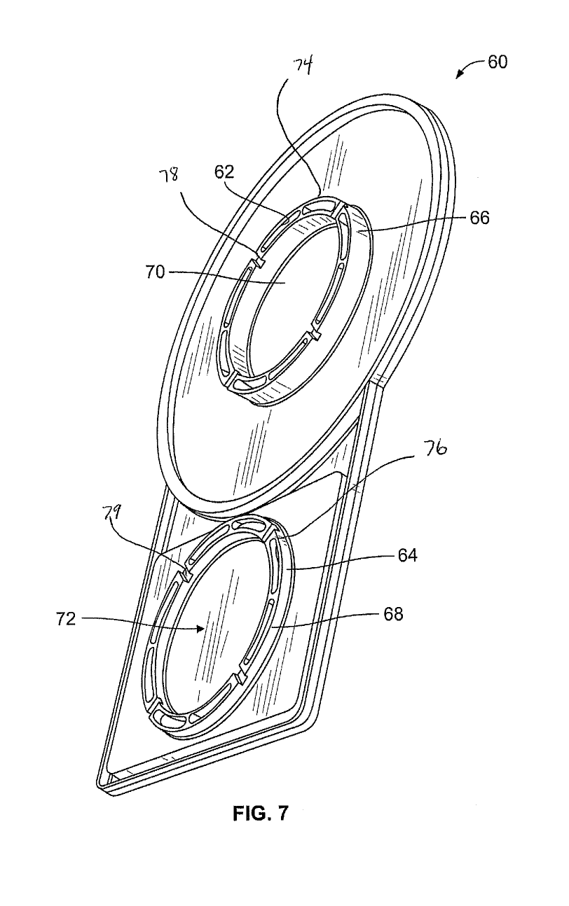

FIG. 6 illustrates a bottom view of a cooking tray 60 according to an embodiment of the present invention. FIG. 7 illustrates an isometric bottom view of the cooking tray 60. Referring to FIGS. 6 and 7, the cooking tray 60 is similar to the cooking tray 10 shown in FIGS. 2 and 3, for example, except that instead of including burner grate mounts 32 and 42 (shown in FIGS. 2 and 3), the cooking tray 60 includes annular supports 62 and 64.

The annular supports 62 and 64 include circumferential walls 66 and 68 respectively, forming a circumferential wall. Heating cavities 70 and 72 are defined by the circumferential walls 66 and 68, respectively. Bottom edges 74 and 76 of the circumferential walls 66 and 68, respectively, are configured with slots or channels 78 and 79 that are configured to correspond to the features of the top of the heating device, such as fins of a burner grate, so that the cooking tray 60 may be supported over the burner grates of heating devices, such as portable propane or butane stoves. As such, the annular supports 62 and 64 support the cooking tray 60 over heating devices, while the heating cavities 70 and 72 provide space for the heating members of the heating devices to heat cooking surfaces on the opposite side of the cooking tray.

The burner grate mounts configured as annular supports 62 and 64 provide a cooking tray 60 having less weight than the cooking tray 10. That is, while the burner grate mounts of the cooking tray 10 secure burner grates to the tray 10, the burner rate mounts 62 and 64 add less weight to cooking tray 60 than burner grate mounts 32 and 42 add to the tray 10. Consequently, the cooking tray 60 is lighter and easier to carry than the cooking tray 10.

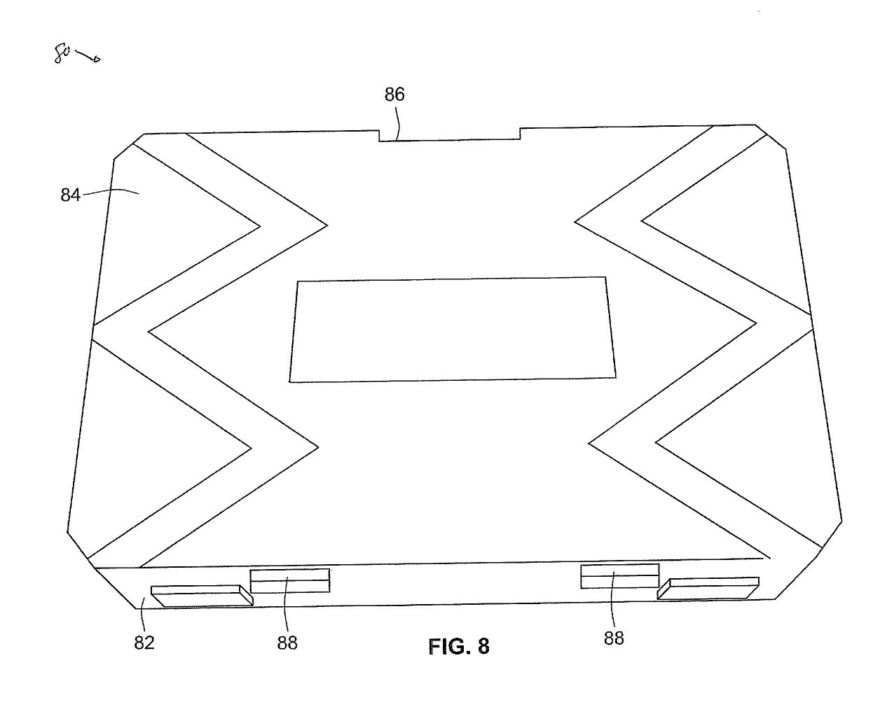

FIG. 8 illustrates a top isometric view of a case 80 according to an embodiment of the present invention. The case 80 is configured to contain the cooking tray 10 or 60 and heating devices in a safe, easy and convenient manner. The case 80 may be formed of a plastic, rubber, or rubber coated plastic, but is preferably formed from an injection-molded thermoplastic such as polypropylene.

The case 80 includes a base 82 and cover 84 pivotally secured to one another through at least one hinge 86. The cover 84 may latchably secure to the base 82 by way of a plurality of clasps, latches 88 or the like on the periphery of the cover 84 that latchably, snapably or otherwise removably secure to reciprocal features formed in the base 82. Optionally, the base 82 may include the latches 88, while the cover 84 includes the reciprocal mating features.

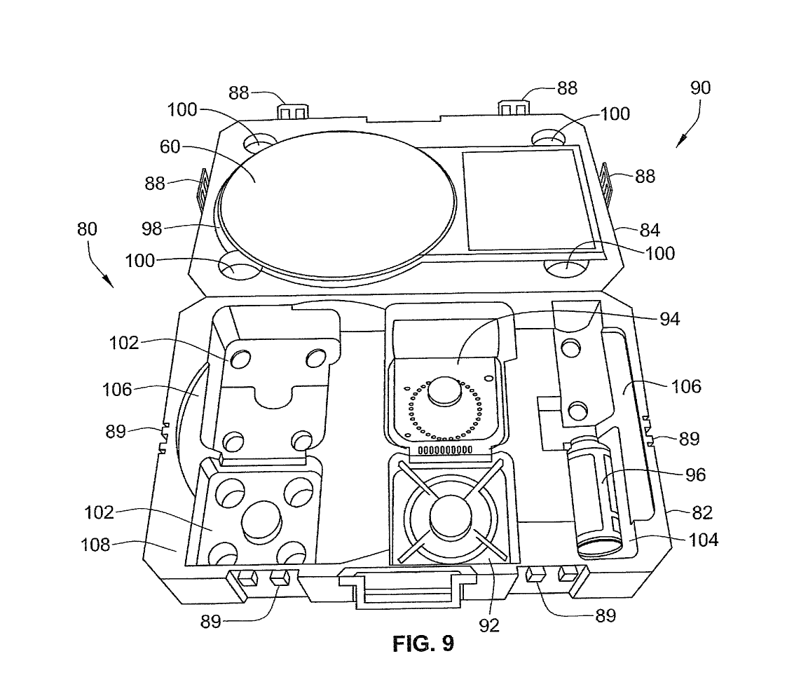

FIG. 9 illustrates a top isometric view of a self-contained cooking system 90 according to an embodiment of the present invention. The self-contained cooking system 90 includes the case 80, the cooking tray 60 (or 10), butane or propane stoves 92, 94 and at least one canister of butane or propane gas 96. As noted above, the case 80 provides a containment unit that houses all cooking components.

As shown in FIG. 9, the cover 84 includes a plurality of latches 88 around the outer perimeter of the cover 84. The latches 88 are configured to engage the reciprocal recessed clasps 89 formed on along the outer perimeter of the base 82.

The cover 84 includes an internal compartment 98 that mirrors the outer edges of the cooking tray 10 or 60 and the base 82 also includes a recessed cooking tray area 106 that mirrors outer edge of the cooking tray 60. The recessed cooking tray area 106 is recessed into a top surface 108 of the base 82. The size and shape of the internal compartments 98 and 106 allow the cooking tray 10 or 60 to be positioned and retained therein while the cover 84 is in the closed position. When the user wants to secure the cooking tray 60 back into the base 82, the user simply aligns the cooking tray 60 with the internal compartment 106 and lowers the cover 84 so that compartment 98 aligns with the cooking tray 60 therein and secures it in place.

According to an embodiment of the invention, the size and shape of the internal compartment 98 allows the cooking tray 60 to snapably secure into the internal chamber 98. Grasping cavities 100 are formed at positions that extend from the internal compartment 98. The grasping cavities 100 connect to the internal compartment 98 and extend outwardly therefrom, thereby also extending away from the cooking tray 60. As such, a user may grasp the underside of the cooking tray 60 and remove it from the internal compartment 98. When the user wants to secure the cooking tray 60 back into the cover 84, the user simply aligns the cooking tray 60 with the internal compartment 98 and urges the cooking tray 60 therein until the cooking tray 60 secures into the internal compartment 98.

The inside of the base 82 includes a plurality of compartments 102 configured to securely retain portable gas cooking devices such as butane stoves 92 and 94. At least one additional semi-cylindrical compartment 104(a) and (b) is configured to securely retain the canister of butane or propane gas 96. The base 82 may also include a compartment for utensils, salt and pepper, etc.

In operation, the case 80 is opened in order provide access to the cooking tray 10 or 60 and the stoves 92 and 94. The cooking tray 10 or 60 is removed from the base 82. In another embodiment, the cooking tray 10 or 60 is removed from the cover 84, as noted above. To begin cooking, the stoves 92 and 94 are removed and positioned ton a flat surface. The stoves 92 and 94 are then activated to begin heating. A bottom surface of the cooking tray 60 is then positioned over the stoves 92 and 94.

When cooking is complete, the cooking tray 10 or 60 is removed from the stoves 92 and 94 and cleaned. The stoves 92 and 94 are deactivated. The stoves 92 and 94 are returned to the compartments 102 which securely retain the stoves 92 and 94. Similarly, the cooking tray 60 is secured back into the internal compartment 106, top cover 84 is closed with internal compartment 98 covering and securing cooking tray 60 in place. The cover 84 may then be pivotally moved toward the base 82 and secured thereto through the latches 88.

Thus, embodiments of the present invention provide a self-contained cooking system 90 that efficiently stores cooking and heating components for easy portable cooking.

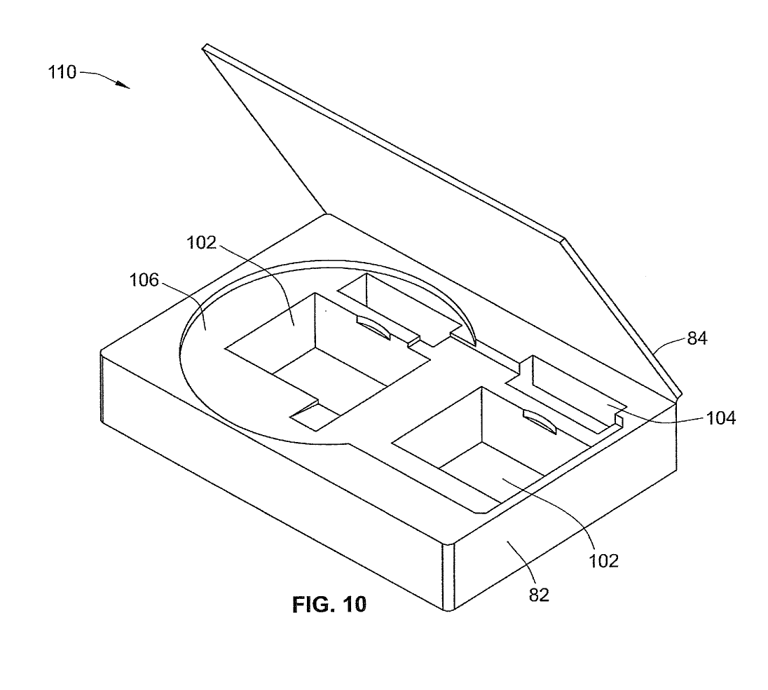

FIG. 10 illustrates a top isometric view of a case 110 in an open position according to an embodiment of the present invention. The case 110 is similar to the case 80 shown in FIG. 8, except that the internal compartments 102 and 104 are shown in a different orientation. Also, instead of the cover 84 including an internal compartment that secures the cooking tray into a secured position, the cooking tray 60 may simply be supported by the recessed cooking area 106, which may or may not snapably secure the cooking tray into position.

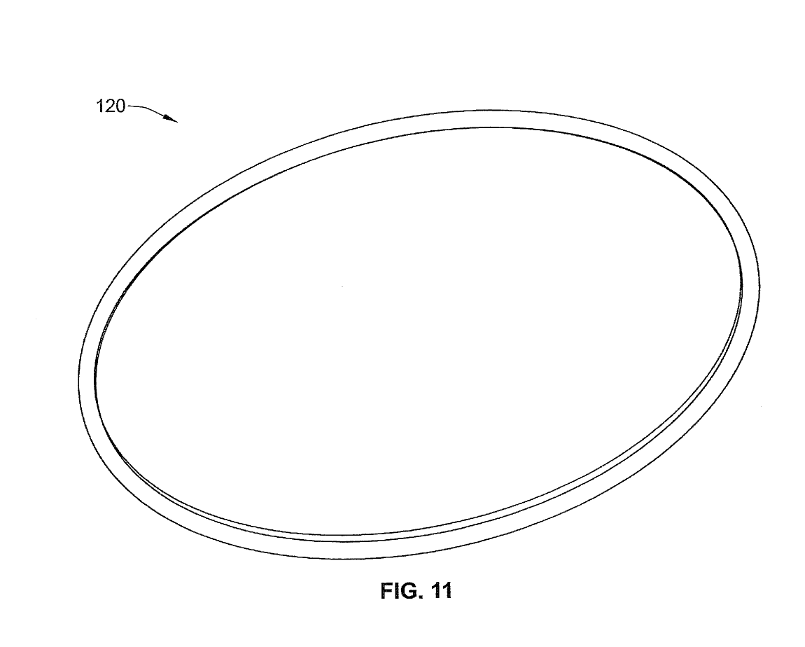

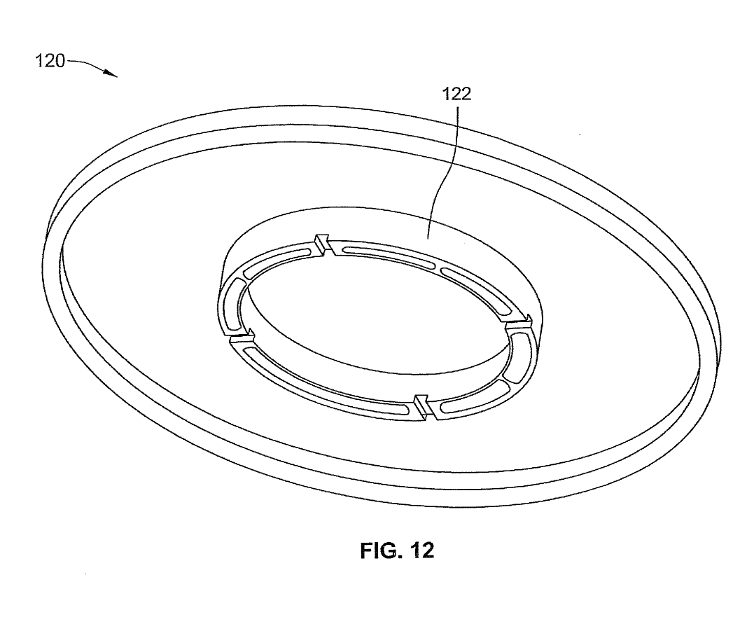

FIG. 11 illustrates an isometric top view of a cooking plate 120 according to an embodiment of the present invention. The cooking plate 120 provides a cooking area that is smaller than the cooking tray 10 or 60. The cooking plate 120 may simply be a circular cooking surface.

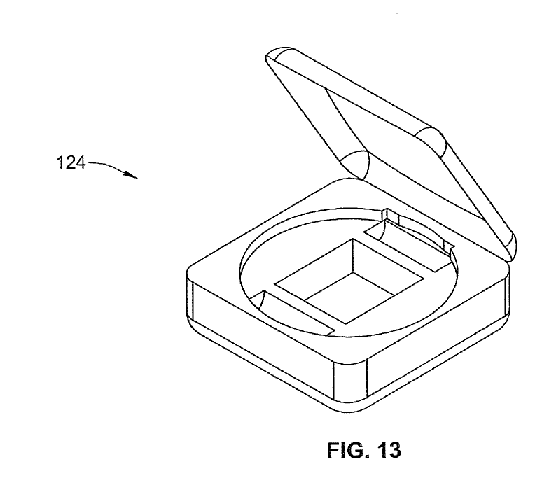

FIG. 12 illustrates an isometric bottom view of the cooking plate 120. The bottom of the cooking plate 120 may include burner grate mounts as shown in FIG. 2, or an annular support as shown and described with respect to FIGS. 6 and 7. While the cooking plate 120 is shown as a circular plate, the cooking plate 120 may be various other shapes and sizes.

FIG. 13 illustrates an isometric top view of a case 124 in an open position according to an embodiment of the present invention. The case 124 is similar to the case 80 or 110, except that it is configured to contain the cooking plate 120, a butane stove and butane gas canister 96. Therefore, the case 124 provides a self-contained cooking system that houses the cooking plate 120 and a butane stove. The self-contained cooking system is simpler, smaller and lighter than that shown in FIG. 9, for example. However, the self-contained cooking system shown in FIGS. 11-13 provides less cooking surface than the trays 10 and 60.

Thus, embodiments of the present invention provide an efficient, lightweight self-contained system for cooking outdoors that is easily packed and carried by a camper, tailgater or picnicker. Embodiments of the cooking tray minimize cost, packing space and cleanup due to the fact that they eliminate the need for multiple pots and pans, a separate stove surface, and separate and distinct bulky heating devices that are carried separately. The cooking trays may be used with small conventional heating elements, such as 16.4 oz disposable propane tanks with detachable burner grates and/or small butane stoves.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A self-contained cooking system, comprising:
a foldable case comprising a tray compartment and at least one heating compartment, said at least one heating compartment configured to securely retain a portable heating device; and
a cooking tray removably secured within said tray compartment.

2. The system of claim 1, wherein said cooking tray comprises:
a main body comprising an integrally formed first cooking area and an integrally formed second cooking area;
wherein said first cooking area is separate and distinct from said second cooking area.

3. The system of claim 1, wherein said cooking tray comprises a circular cooking disc having a cooking surface and an annular support extending from a side opposite said cooking surface.

4. The system of claim 1, wherein said cooking tray comprises at least one annular support configured to support said cooking tray above the at least one heating compartment.

5. The system of claim 1, wherein said case comprises a cover latchably secured to a base, wherein said cover comprises said tray compartment and said base comprises said at least one heating compartment.

6. The system of claim 1, wherein said case is operable to be opened, and said cooking tray is removed from said tray compartment and positioned over said at least one heating compartment.

7. The system of claim 1, wherein said case comprises at least one semi-cylindrical compartment configured to removably retain a canister of butane gas.

8. The system of claim 1, wherein said at least one heating device is at least one butane receptacle.

9. The cooking system of claim 1, wherein said cooking tray is a unitary piece of metal.

10. The cooking system of claim 2, wherein said first cooking area is integrally connected to said second cooking area through an intermediate portion.

11. The cooking system of claim 2, wherein said first cooking area further comprises a drainage channel.

12. The cooking system of claim 2, wherein said second cooking area comprises a recessed cooking pocket.

13. A self-contained cooking system, comprising:
a foldable case comprising a tray compartment and at least one heating compartment;
a cooking tray removably secured within said tray compartment; and
at least one heating device removably secured within said at least one heating compartment,
wherein said foldable case is pivotable between open and closed positions, wherein said cooking tray and said at least one heating device are securely contained within said foldable case in said closed position.

14. The system of claim 13, wherein said cooking tray comprises:
a main body comprising an integrally formed first cooking area and an integrally formed second cooking area;
wherein said first cooking area is separate and distinct from said second cooking area.

15. The system of claim 13, wherein said cooking tray comprises a circular cooking disc having a cooking surface and an annular support extending from a side opposite said cooking surface.

16. The system of claim 13, wherein said cooking tray comprises at least one annular support configured to support said cooking tray above the at least one heating compartment.

17. The system of claim 13, wherein said case comprises a cover latchably secured to a base, wherein said cover comprises said tray compartment and said base comprises said at least one heating compartment.

18. The system of claim 13, wherein, in said open position, said cooking tray is removed from said tray compartment and positioned over said at least one heating compartment.

19. The system of claim 13, wherein said case comprises at least one semi-cylindrical compartment configured to removably retain a canister of butane gas.

20. A self-contained cooking system, comprising:
a foldable case comprising a tray compartment and at least one heating compartment, wherein said case comprises a cover latchably secured to a base;
a cooking tray removably secured within said tray compartment, wherein said cooking tray comprises at least one annular support configured to support said cooking tray above a surface; and
at least one heating device removably secured within said at least one heating compartment,
said foldable case being pivotable between open and closed positions, wherein said cooking tray and said at least one heating device are securely contained within said foldable case in said closed position, wherein cooking tray is removed from said tray compartment and positioned over said at least one heating device positioned within said at least one heating compartment.
